(19) United States
(12) Patent Application Publication
(10) Pub. No.: US 2025/0061057 A1
(43) Pub. Date: Feb. 20, 2025

(54) COMPUTING SYSTEM AND OPERATING METHOD THEREOF

(71) Applicant: Samsung Electronics Co., Ltd., Suwon-si (KR)

(72) Inventors: JUNGHO YEOM, Suwon-si (KR); EUNYOUNG KWON, Suwon-si (KR); DO KYUN KIM, Suwon-si (KR); SANGHOAN CHANG, Suwon-si (KR)

(21) Appl. No.: 18/765,664

(22) Filed: Jul. 8, 2024

(30) Foreign Application Priority Data
Aug. 17, 2023 (KR) 10-2023-0107882
Dec. 7, 2023 (KR) 10-2023-0177027

(51) Int. Cl. G06F 12/02; G06F 13/42

(52) U.S. Cl. CPC G06F 12/0246; G06F 13/4221; G06F 2212/7205; G06F 2213/0026

(57) ABSTRACT

A computing system according to some embodiments includes a host configured to distribute and allocate process data associated with a plurality of processes to a plurality of logic addresses, determine a valid bit corresponding to a logic address among a plurality of logic addresses, whether a process among the plurality of the processes corresponding to the logic address is executing, and generate an update information including the valid bit and the logic address corresponding to the valid bit, and a storage device that receives the update information from the host.

### CROSS-REFERENCE TO RELATED APPLICATIONS

This application claims priority to and the benefit of Korean Patent Application No. 10-2023-0107882 filed in the Korean Intellectual Property Office on Aug. 17, 2023, and Korean Patent Application No. 10-2023-0177027 filed in the Korean Intellectual Property Office on Dec. 7, 2023, the entire contents of which are incorporated herein by reference.

### BACKGROUND

The present disclosure relates to a computing system and an operating method thereof.

A computing system may provide various IT services to users. Recently, as application fields utilizing artificial intelligence and big data have increased, the amount of data processed in computing systems is increasing to provide various IT services to the users. Various technologies are being developed to overcome physical limitations in memory capacity of the computing systems. Particularly, compute express link (CXL) is a newly proposed interface to more efficiently utilize accelerators, memories, and storage devices used along with CPUs in high performance computing systems.

### SUMMARY

The present disclosure is intended to efficiently manage data stored in the computing system.

A computing system according to some embodiments includes a host distributing and allocating process data for each of a plurality of processes to a plurality of logic addresses, determining a valid bit that indicates whether a respective one of the plurality of the processes corresponding to a respective one of the plurality of logic addresses is executing, and generating update information including the valid bit and the respective one of the plurality of logic addresses corresponding to the valid bit, and a storage device that receives the update information from the host.

A method of a computing system according to some embodiments includes distributing and assigning process data for each of a plurality of processes to respective ones of a plurality of logic addresses, allocating a valid bit indicating whether a respective process of the plurality of processes corresponding to a logic address of the plurality of logic addresses is executing, generating an update information including the valid bit and the logic address corresponding to the valid bit, mapping a first logic address among the plurality of logic addresses of a first type to a storage address for a storage device including a non-volatile memory, and performing garbage collection on the storage device at the storage address corresponding to the logic address when the valid bit indicates that the process is not executing based on the update information.

A CXL device according to some embodiments includes a CXL storage including a non-volatile memory corresponding to a first type of a first logic address among a plurality of logic addresses, receive a valid bit indicating whether a process corresponding to the first logic address of the first type is executing, and performing garbage collection for the non-volatile memory based on the valid bit, and a CXL memory including a volatile memory corresponding to a second type of a second logic address among the plurality of logic addresses.

### BRIEF DESCRIPTION OF THE DRAWINGS

FIG. 1 is a block diagram showing a computing system according to some embodiments.

FIG. 2 is a block diagram showing a CXL storage according to some embodiments.

FIG. 3 is a block diagram showing in detail some components of a computing system according to some embodiments.

FIG. 4 is a view showing a memory region managed by a computing system according to FIG. 1.

FIG. 5 is a flowchart showing an operating method of a computing system according to FIG. 1.

FIG. 6, FIG. 7, FIG. 8, and FIG. 9 are views showing a mapping table according to operations of a computing system according to some embodiments.

FIG. 10 is a block diagram showing a computing system according to some embodiments.

FIG. 11 is a block diagram showing a server system according to some embodiments.

### DETAILED DESCRIPTION OF THE EMBODIMENTS

In the following detailed description, certain embodiments of the present disclosure have been shown and described, simply by way of illustration. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification. In a flowchart described with reference to the drawings, an order of operations may be changed, several operations may be merged, some operations may be divided, and specific operations may not be performed.

In addition, expressions written in the singular may be construed in the singular or plural unless an explicit expression such as “one” or “single” is used. Terms including ordinal numbers such as first, second, and the like will be used to describe various components, and are not to be interpreted as limiting these components. These terms may be used for the purpose of distinguishing one element from other elements.

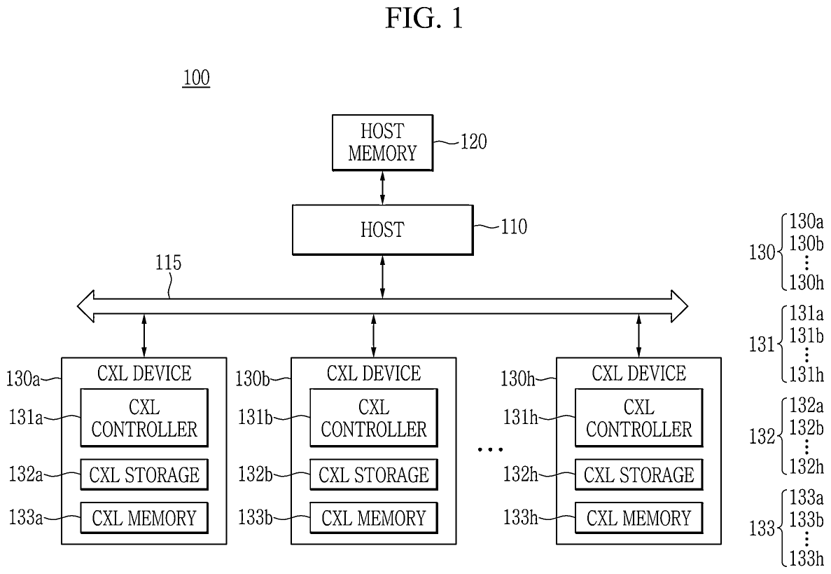

FIG. 1 is a block diagram showing a computing system according to some embodiments.

Referring to FIG. 1, a computing system 100 may include a host 110, a host memory 120, and at least one CXL (compute express link) device 130. CXL is an open standard for high-speed, high capacity CPU-to-device and CPU-to-memory connections, designed for high performance data center computers. CXL is built on the serial PCI Express (PCIe) physical and electrical interface and includes PCIe-based block input/output protocol (CXL.io) and cache-coherent protocols for accessing system memory (CXL.cache) and device memory (CXL.mem). The serial communication and pooling capabilities allows CXL memory to overcome performance and socket packaging limitations of common DIMM memory when implementing high storage capacities.

In some embodiments, the computing system 100 may be included in user devices such as personal computers, laptop computing, servers, media players, digital cameras, etc., or automotive devices such as navigation devices, black boxes, automotive electronic devices, etc. It can be included in the same vehicle equipment. In some embodiments, the computing system 100 is a mobile system such as a portable communication terminal (a mobile phone), a smart phone, a tablet PC (tablet personal computer), a wearable device, a healthcare device, or an IOT (internet of things) device.

The host 110 may control the overall operations of a computing system 100. In some embodiments, the host 110 may be one of various processors, such as a central processing unit (CPU), a graphics processing unit (GPU), a neural processing unit (NPU), or a data processing unit (DPU). In some embodiments, the host 110 may include a single core processor or a multi-core processor.

In some embodiments, the host 110 may drive a plurality of processes. The host 110 may distribute and store data needed to drive the plurality of processes in a host memory 120 and at least one CXL device 130. Hereinafter, the data required to drive the plurality of processes is referred to as process data. Specifically, when the host 110 requires a fast input/output speed, the process data may be stored in the host memory 120. The host 110 may store the process data in at least one CXL device 130 when consistency is important. That is, the host 110 may distribute and store the data in the plurality of CXL storages 132, the plurality of CXL memories 133, and the host memory 120, respectively.

In some embodiments, some processes may be terminated while the host 110 is driving, running, or executing a plurality of processes. When the process terminates, the data corresponding to the terminated process is referred to as invalid data. Additionally, the data required for the driving process, running process, or executing process, is referred to as valid data. The host 110 may determine a valid bit for each address of the plurality of CXL storages 132, the plurality of CXL memories 133, and the host memory 120. The valid bit may indicate whether the process data stored in the corresponding address is the invalid data or the valid data. In other words, the valid bit may indicate whether the process corresponding to the address is driving, running, or executing. In some embodiments, when the valid bit is 1, it may indicate that the process is being driven or executed by the host 110, and when the valid bit is 0, it may indicate that the process is being terminated by the host 110. In some embodiments, the host 110 may generate an update information when the valid bit changes. The update information may include a changed valid bit and an address corresponding to the changed valid bit. For example, the host 110 may generate an update information when a driving process, running process, or executing process is terminated. The host 110 may transmit the update information to the CXL device 130a. In some embodiments, the host 110 may store the update information in the host memory 120. In some embodiments, the host memory 120 and the CXL memory 133a may be connected through a separate coherency interface. When the consistency is maintained between the host memory 120 and the CXL memory 133a, even if the host 110 does not transmit the update information to the CXL device 130a, the CXL device 130a may refer to the update information in the CXL memory 133a.

Meanwhile, the host 110 may determine the valid bit for each address of the plurality of CXL storages 132. In this case, the host 110 may generate the update information when the valid bit for each address of the plurality of CXL storages 132 changes.

The host memory 120 may be used as a main memory or a system memory of the computing system 100. In some embodiments, the host memory 120 may be a dynamic random access memory (DRAM) device and may have a form of a dual in-line memory module (DIMM). However, the range of the present disclosure is not limited thereto, and the memory 120 may include a non-volatile memory such as a flash memory, a PRAM, a RRAM, a MRAM, etc.

The host memory 120 may communicate directly with the host 110 through a double data rate (DDR) interface. In some embodiments, the host 110 may include a memory controller configured to control the host memory 120. However, the range of the present disclosure is not limited thereto, and the host memory 120 may communicate with the host 110 through various interfaces.

At least one CXL device 130 may be implemented as an individual memory device or a memory module. Each of at least one CXL device 130 may be connected to the CXL interface 115 through different physical ports.

The CXL device 130a may include a CXL controller 131a, a CXL storage 132a, and a CXL memory 133a.

The CXL controller 131a may include an intellectual property (IP) circuit designed to implement an application specific integrated circuit (ASIC) and/or a field-programmable gate array (FPGA). In various embodiments, the CXL controller 131 may be implemented to support the CXL protocol (e.g., CXL 2.0 protocol or any other version). The CXL controller 131 may convert the signals of the memory interface of the CXL packet and the CXL memory 133a, and the signals of the memory interface of the CXL packet and the CXL storage 132. For example, the CXL controller 131a may convert the logic address received from the host 110 through the CXL interface 115 into a CXL address. At this time, the CXL address may include a CXL memory address for the CXL memory 133a and a CXL storage address for the CXL storage 132a. The CXL address may be an address managed by the CXL controller 131a.

The address mapping operation may be an operation of converting or mapping between the logic address managed by the host 110 and the address of the CXL memory 133a or the address of the CXL storage 132a in the CXL device 130a.

For example, the CXL controller 131a may control the CXL storage 132a or the CXL memory 133a so that the CXL packet transmitted from the host 110 is stored in the CXL storage 132a or the CXL memory 133a. Specifically, the CXL controller 131a may convert the data received from the host 110 to be stored in the CXL storage 132a or the CXL memory 133a, or convert the data stored in the CXL storage 132a or the CXL memory 133a to be transmitted to the host 110.

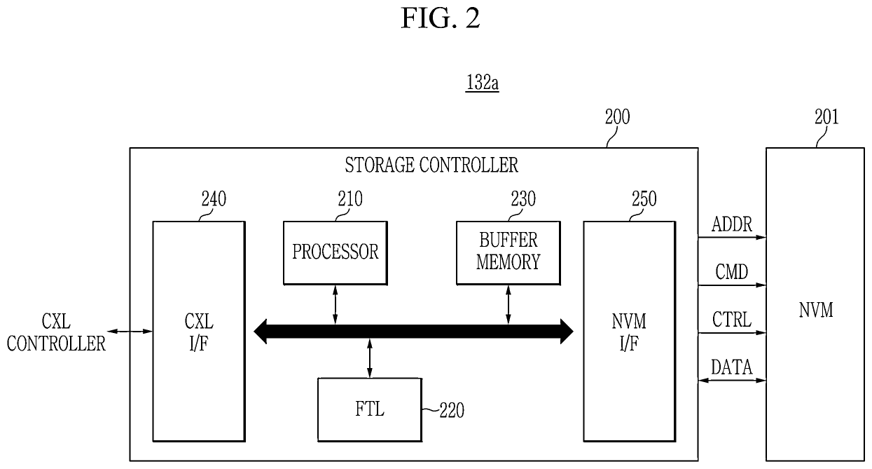

The CXL storage 132a may store the data in the CXL storage address received from the CXL controller 131a. In relation to the CXL storage 132a, FIG. 2 is referred together with FIG. 1.

FIG. 2 is a block diagram showing a CXL storage according to some embodiments.

As shown in FIG. 2, the CXL storage 132a may include a storage controller 200 and a non-volatile memory (NVM) 201. The CXL storage 132a may store data or process data in response to the control signal of the CXL controller 131a.

The storage controller 200 may control the operation of the CXL storage 132a. For example, the storage controller 200 may provide an address ADDR, a command CMD, a control signal CTRL, etc. to the non-volatile memory 201 in response to a control signal received from the CXL controller 131a. That is, the storage controller 200 may provide signals to the non-volatile memory 201 to program data into the non-volatile memory 201, or read data from the non-volatile memory 201. Additionally, the storage controller 200 and the non-volatile memory 201 may exchange data DATA.

Specifically, the storage controller 200 may include a processor 210, a flash translation layer (FTL) 220, a buffer memory 230, a CXL interface 240, and a memory interface 250.

The processor 210 may control the overall operation of the storage controller 200. The processor 210 may control the storage controller 200 by driving, running, or executing the firmware loaded on the FTL 220. In some embodiments, the processor 210 may include a central processing unit (CPU), a controller, or an application specific semiconductor (ASIC).

The processor 210 may drive various firmware or software driven on the storage controller 200. The processor 210 may use the buffer memory 230 as the operating memory of the processor 210. Additionally, the processor 210 may use the non-volatile memory 201 as the operating memory of the processor 210.

The flash transition layer (FTL) 220 may include firmware or software for managing data programming, data reading, and a sub-block and/or block erase operation, the like of the non-volatile memory 201. The firmware of the FTL 220 may be executed by the processor 210.

In some embodiments, the FTL 220 may perform various maintenance operations to efficiently use the non-volatile memory 201. Specifically, the FTL 220 may perform several functions such as address mapping and garbage collection.

The FTL 220 may perform an address mapping operation that changes the CXL storage address received from the CXL controller 131a to a physical address used to actually store data in the non-volatile memory 201. Specifically, the FTL 220 may map the CXL storage address from the CXL controller 131a and the physical address of the non-volatile memory 201 by using an address mapping table. The address mapping operation may be an operation of converting or mapping between the CXL storage address managed by the CXL controller 131a and the address of the non-volatile memory 201.

The FTL 220 may perform garbage collection to secure a capacity that is usable within the non-volatile memory 201. The garbage collection operation may be an operation that copies the valid data in the block of the non-volatile memory 201 to a new block and erases the existing block so that the existing block may be reused. In other words, the operation of the FTL 220 removing invalid pages and merging pages programmed with the valid data is referred to as a garbage collection. Since the non-volatile memory 201 cannot be overwritten, when receiving a request from the host 110 to program new data in a page where the data is programmed, the storage controller 200 may program the new data in the new page of the non-volatile memory 201. At this time, the pages where data was previously programmed may be invalidated. As data is continuously written to a flash memory, the valid data may be scattered throughout the flash memory, and the FTL 220 performs the garbage collection to secure a storage space in which data programming is possible, that is, the free block.

Meanwhile, the CXL storage 132a may not know information about the process terminated in the host 110. Accordingly, the CXL storage 132a may perform the garbage collection even on the page including the invalid data. The performing of the garbage collection on the invalid data may cause endurance and performance (Quality of Service, QoS) deterioration of the CXL storage 132a. Meanwhile, the host 110 according to some embodiments may change the valid bit corresponding to the address where the invalid data is stored. The host 110 may generate an address corresponding to the changed valid bit and update information including the changed valid bit. The host 110 may transmit the updated information to the CXL storage 132a. The FTL 220 may perform the garbage collection based on the valid bit in the updated information. Specifically, the FTL 220 may perform the garbage collection on the pages including the valid data and remove the pages including the invalid data. Accordingly, the performance (QoS) of the CXL storage 132a may be improved and the durability may be improved.

In some embodiments, the host 110 may store the generated update information in the host memory 120. If the consistency between the host memory 120 and CXL memory 133a is maintained, the CXL storage 132a may perform the garbage collection based on the valid bit in the update information in the CXL memory 133a.

In some embodiments, the FTL 220 may perform the garbage collection operation when the available memory region within the non-volatile memory 201 exceeds a predetermined garbage collection level. The garbage collection level may be a predetermined threshold value for the FTL 220 to determine the initiation of the garbage collection. In some embodiments, the garbage collection operation may be performed by a sub-block unit as well as by a block unit. In some embodiments, the FTL 220 may perform the garbage collection operations periodically, i.e., with a regular time period between performing garbage collection operations.

In some embodiments, the FTL 220 may receive a trim command from the host 110. The trim command may be a command that notifies that the data existing in a specific region of CXL storage 132a is no longer used in the CXL storage 132a. The FTL 220 may perform the garbage collection based on the valid bit in the update information in response to receiving a trim instruction from the host 110.

In some embodiments, the FTL 220 may store data necessary to perform the operation of the FTL 220. For example, the FTL 220 may store a block information of the non-volatile memory 201, a garbage collection level to perform the garbage collection on the non-volatile memory 201, the address mapping table used to convert the CXL storage address into the physical address of the non-volatile memory 201, the address mapping table, managed by the garbage collection or a wear leveling operation, etc. Meanwhile, the present disclosure is not limited thereto, and the data for performing the operation of FTL 220 may be stored in the buffer memory 230 and may be stored in the non-volatile memory 201.

The buffer memory 230 may store instructions and data that are executed and processed by the storage controller 200. The buffer memory 230 may temporarily store data stored in the non-volatile memory 201 or data that is to be stored.

In some embodiments, the buffer memory 230 may be implemented as a volatile memory, such as dynamic random access memory (DRAM), static RAM (SRAM), etc. However, it is not limited thereto, the buffer memory 230 may be implemented as a resistive non-volatile memory such as a magnetic RAM (MRAM), a phase change RAM (PRAM), or a resistive RAM (ReRAM), etc. a flash memory, various non-volatile memory such as a nano floating gate memory (NFGM), a polymer random access memory (PoRAM), or a ferroelectric random access memory (FRAM), etc.

In some embodiments, the buffer memory 230 may store a code data required for an initial booting of the CXL storage 132a. The buffer memory 230 may buffer the CXL storage address, the request signal, the data, the command, etc. received from the CXL controller 131a. The signals buffered in the buffer memory 230 may be transmitted to the non-volatile memory 201 through the memory interface 250 to be used. For example, the data buffered in the buffer memory 230 may be programmed in the non-volatile memory 201.

In FIG. 2, the buffer memory 230 is shown as being provided inside the storage controller 200, but the present disclosure is not limited thereto, and the buffer memory 230 may be provided outside the storage controller 200 and may be part of the CXL memory 133a.

The CXL interface 240 may transmit and receive packets with the CXL controller 131a. The packet received from the CXL controller 131a through the CXL interface 240 may include a command, data to be programmed in the non-volatile memory 201, and a CXL storage address to program the data. The packet transmitted from the storage controller 200 to the CXL controller 131a through the CXL interface 240 may include a response to a command or data read from the non-volatile memory 201.

The memory interface 250 may provide a signal transmission and reception with the non-volatile memory 201. The memory interface 250 may transmit data to be programmed into the non-volatile memory 201, a command, a physical address where the data will be programmed, and a control signal to the non-volatile memory 201, or receive data read from the non-volatile memory 201. This memory interface 250 may be implemented to comply with standard protocols such as Toggle or ONFI.

The non-volatile memory 201 may include a plurality of dies, or a plurality of chips, including a memory cell array. For example, the non-volatile memory 201 may include a plurality of chips, and each of the plurality of chips may include a plurality of dies. In some embodiments, the non-volatile memory 201 may also include a plurality of channels, each of which includes a plurality of chips.

The non-volatile memory 201 may include a NAND flash memory. In some embodiments, the non-volatile memory 201 may include an electrically erasable programmable read-only memory (EEPROM), a phase change random access memory (PRAM), a resistive RAM (ReRAM), a resistance random access memory (RRAM), a nano floating gate memory (NFGM), a polymer random access memory (PoRAM), a magnetic random access memory (MRAM), a ferroelectric random access memory (FRAM) or memories similar thereto. Hereinafter, in the present disclosure, the non-volatile memory 201 will be explained assuming that it is a NAND flash memory device.

Again referring to FIG. 1, the CXL memory 133a may store data in the CXL memory address received from the CXL controller 131a.

In some embodiments, the CXL memory 133a may include one among a dynamic random access memory (DRAM), a high bandwidth memory (HBM), a hybrid memory cube (HMC), a dual in-line memory module (DIMM), Optane DIMM, a double data rate synchronous DRAM (DDR SDRAM), a low-power double data rate synchronous dynamic random access memory (LPDDR SDRAM), or a combination thereof.

In some embodiments, the host 110 and at least one CXL device 130 may be configured to share the same interface. For example, the host 110 and at least one CXL device 130 may communicate with each other through the CXL interface 115. The host 110 may access the CXL memory 133 of the CXL device 130 through the CXL interface 115, and the CXL device 130 may also access the memories 120 of the host 110 and/or the CXL memory 133 of the another CXL device 130 through the CXL interface 115.

In some embodiments, the CXL interface 115 may refer to low-latency and high-bandwidth links that enable a variety of connections between accelerators, memory devices, or various electronic devices by supporting a coherency, a memory access, and a dynamic protocol muxing of an input/output protocol (IO protocol). Hereinafter, for better understanding and ease of description, it is assumed that the host 110 and the CXL device 130 communicate with each other through the CXL interface 115. Meanwhile, the present disclosure is not limited to the CXL interface 115, and host 110 and the CXL device 130 may communicate with each other based on various computing interfaces such as GEN-Z protocol, NVLink protocol, CCIX protocol, Open CAPI protocol, etc.

CXL, which is an open industry standard for communications based on peripheral component interconnect express (PCIe) 5.0, can provide a fixed and/or relatively short packet size, resulting in a relatively high bandwidth and a relatively low fixed latency. As such, the CXL may support cache-coherency, and CXL may be well suited for creating or generating connections to memories. CXL may be used in the server to provide connections between the host 110 and the CXL devices 130 (e.g., accelerators, memory devices, and network interface circuits (or “network interface controllers” or network interface cards (NICs))).

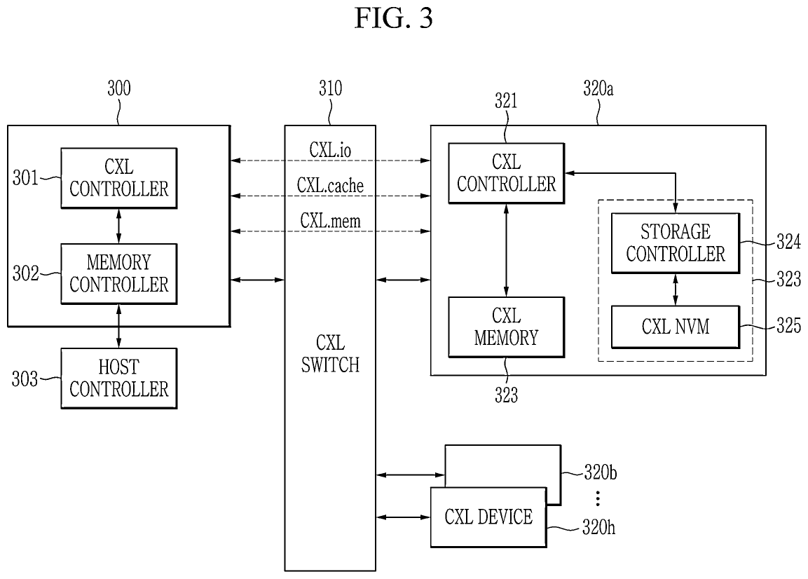

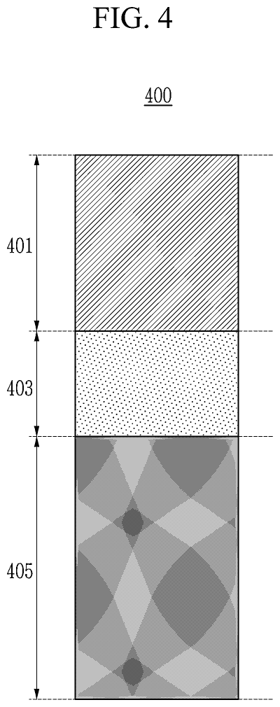

FIG. 3 is a detailed block diagram showing some constituent elements of a computer system according to some embodiments.

Referring to FIG. 3, the host 300 and the CXL devices 320a, 320b, . . . , and 320h may communicate with each other through a CXL switch 310. The CXL switch 310 may be a component included in a CXL interface. The CXL switch 310 may be configured to mediate communication between a host 300 and CXL devices 320. For example, when the host 300 and the CXL devices 320 communicate with each other, the CXL switch 310 may be configured to transmit information such as a request, data, a response, or a signal transmitted from the host 300 or the CXL devices 320 to the CXL devices 320 or the host 300. When the CXL devices 320a, 320b, . . . , and 320h communicate with each other, the CXL switch 310 may be configured to pass information such as a request, data, a response, or a signal between the CXL devices 320a, 320b, . . . , and 320h.

The host 300 may include a CXL controller 301. The CXL controller 301 may communicate with the CXL device 320 through the CXL switch 310. The CXL controller 301 may be connected to the memory controller 302 and associated host memory 303.

The CXL switch 310 may be used to implement a memory cluster through one-to-many and many-to-one switching between the connected CXL devices 320a, 320b, . . . , and 320h.

In addition to providing packet-switching functionality for CXL packets, the CXL switch 310 may be used to connect the CXL devices 320a, 320b, . . . , and 320h to one or more hosts 300. The CXL switch 310 (i) may allow the CXL devices 320a, 320b, . . . , and 320h to include different types of memory with different characteristics, (ii) may virtualize memories of the CXL devices 320a, 320b, . . . , and 320h and allow data of different characteristics (e.g., access frequency) to be stored in an appropriate type of memory, and (iii) may support remote direct memory access (RDMA). Herein, “virtualizing” the memory indicates performing memory address translation between a processing circuit and a memory.

As shown in FIG. 3, a single CXL link may include three multiplexed sub-protocols. Specifically, the CXL link may include a CXL.io, a CXL.cache, and CXL.mem, which are coherent protocols. The CXL.io is based on a peripheral component interconnect express (PCIe) specification and may be a protocol related to a device discovery, a configuration, a register access, an interruption, etc. The CXL.cache may be a protocol that configures the CXL device 320a to access the host memory 303. The CXL.mem may be a protocol that configures the host 300 to access the CXL memory 322 and the CXL storage 323 of the CXL device 320a.

The host 300 may manage an accessible memory space. Managing the memory space may include a translation between a virtual address used by the host 300 and an address (e.g., a physical address or an additional virtual address) recognized by the CXL device 320a. In some embodiments, the host 300 may transmit a command (e.g., a memory save/load command) to the CXL storage 323 and the CXL memory 322 through a first protocol (e.g., the CXL.mem). The host 300 may recognize the CXL storage 323 and the CXL memory 322 as the same type of a memory.

Meanwhile, the present disclosure is not limited thereto, the CXL devices (320a, 320b, . . . , 320h) may communicate with the host 300 by using a storage interface and/or a protocol of an arbitrary type such as a peripheral component interconnect express (PCIe), NVMe, NVMe-over-fabric (NVMe-oF), NVMe Key-Value (NVMe-KV), SATA, SCSI, etc. In some embodiments, the CXL devices 320a, 320b, . . . , 320h may implement a coherent (e.g., a memory coherent, a cache coherent, etc.).

The CXL device 320a may include a CXL controller 321, a CXL storage 323 that includes a storage controller 324, and a memory such as CXL NVM 325. Other CXL devices 320b, . . . , 320h may also include the same as or similar components to the CXL device 320a.

The CXL controller 321 may be connected to the CXL switch 310. The CXL controller 321 may communicate with the host 300 and/or other CXL devices through the CXL switch 310. The CXL controller 321 may include a PCIe 5.0 (or other version) architecture for the CXL.io path, and may add a CXL.cache and a CXL.mem path specified to the CXL.

The CXL controller 321 may be configured to manage the CXL memory 322. In some embodiments, the CXL controller 321 may map a logic address received from the host 300 to a CXL memory address corresponding to the CXL memory 322. In some embodiments, the CXL controller 321 may store data received from the host 300 in the CXL memory 322 or read the stored data. In some embodiments, at least a portion of an area of the CXL memory 322 may be allocated as a dedicated area for the CXL device 320a, and a remaining area may be used as an area that is accessible by the host 300 or the other CXL devices 320b, . . . , and 320h.

The CXL controller 321 may be configured to manage the CXL storage 323. In some embodiments, the CXL controller 321 may map the logic address received from the host 300 to the CXL storage address corresponding to the CXL storage 323. In some embodiments, the CXL controller 321 may store data received from the host 300 in the CXL storage 323 or read the stored data.

In some embodiments, the CXL controller 321 may be implemented to comply with standard protocols such as a DDR interface, a LPDDR interface, etc.

The CXL memory 322 may store data received from the host 300 in the CXL memory address under the control of the CXL controller 321.

The CXL storage 323 may include a storage controller 324 and a CXL NVM 325. The storage controller 324 may map the CXL storage address received through the CXL controller 321 to the physical address of the CXL NVM 325. The storage controller 324 may control the CXL NVM 325 so that data is stored in the CXL NVM 325 or data is read from the CXL NVM 325. The storage controller 324 may be configured to manage the CXL NVM 325. In some embodiments, the storage controller 324 may perform the garbage collection periodically or with a regular time period.

FIG. 4 is a view showing a memory region managed by a computing system according to FIG. 1.

The host 110 may manage the host memory 120 and the memory of the CXL memory 133a and the CXL storage 132a in at least one CXL device 130a connected through the CXL interface 115.

As shown in FIG. 4, the memory region 400 of the computing system 100 may include a host memory region 401, a CXL memory region 403, and a CXL storage region 405. The CXL memory region 403 and the CXL storage region 405 may be referred to as a CXL region.

The memory region 400 can include upper and lower memory addresses for each region. For example, the upper memory address may be a logic address assigned by the host 110. In some embodiments, the host 110 may assign separate upper memory addresses to the host memory region 401, the CXL memory region 403, and the CXL storage region 405. For example, a first type of the logic address may be assigned to host memory region 401, a second type of the logic address may be assigned to CXL memory region 403, and a third type of the logic address may be assigned to CXL storage region 405.

Meanwhile, the host 110 is described as generating the update information when the operation of the process corresponding to the first type of the logic address, the second type of the logic address, and the third type of the logic address changes, but the present disclosure is not limited thereto, and the host 110 may generate the update information when the operation of the process corresponding to the logic address of the third type changes. In other words, the host 110 may not generate the update information even if the operation of the process corresponding to the first type of the logic address and the second type of the logic address changes.

In some embodiments, the host 110 may generate the update information when the operation of the process corresponding to the first type of the logic address and the second type of the logic address changes. The host 110 may not transmit the update information for the first type of the logic address to the host memory 120 and may not transmit the update information for the second type of the logic address to the CXL device 130a.

For example, the lower memory address may be the CXL address of the CXL controller 131a. In some embodiments, the lower memory address may be a physical address within the host memory 120, the CXL memory 133a, and the CXL storage 132a.

The host 110 may distribute and allocate the process data to the host memory region 401, the CXL memory region 403, and the CXL storage region 405. Specifically, the host 110 may distribute and store the process data in the host memory region 401, the CXL memory region 403, and the CXL storage region 405 based on the input/output speed and the degree of the consistency of the process data. The degree of consistency may indicate an accuracy of the process data. For example, the host memory region 401 may include data that requires a fast input/output speed. The CXL memory region 403 or the CXL storage region 405 may include data requiring the consistency.

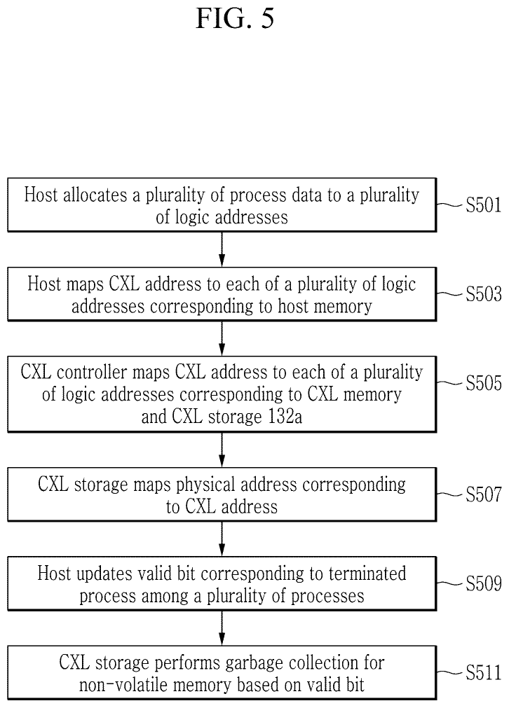

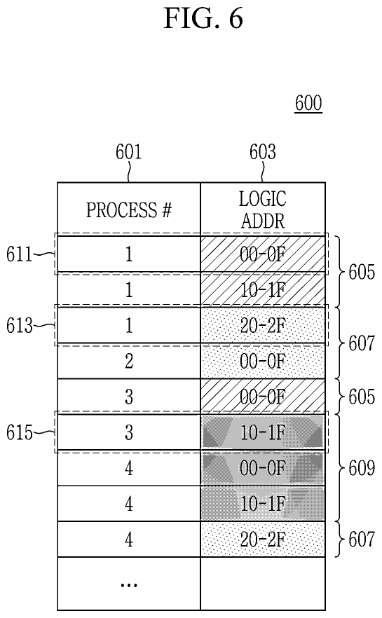

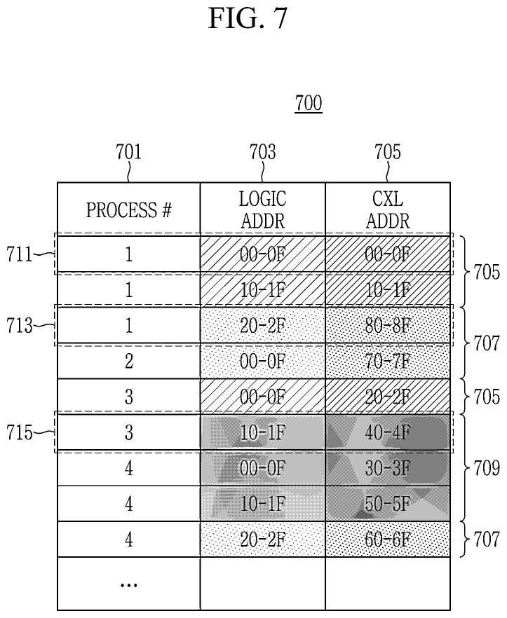

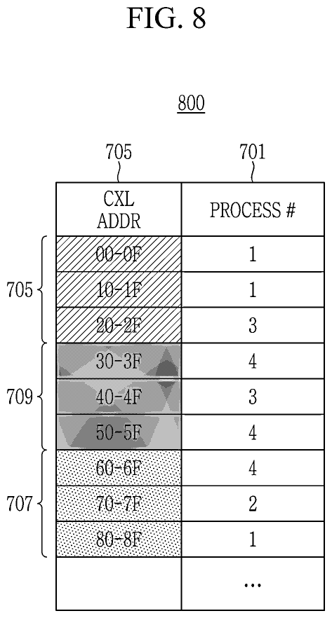

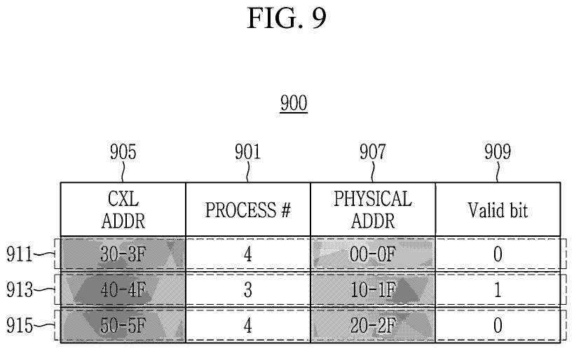

FIG. 5 is a flowchart showing an operating method of a computing system according to FIG. 1. FIG. 6, FIG. 7, FIG. 8, and FIG. 9 are views showing a mapping table according to operations of a computing system according to some embodiments.

First, the host 110 allocates a plurality of process data to a plurality of logic addresses (S501).

For example, the plurality of logic addresses may be logic addresses for the host memory 120, the CXL memory 133a, and the CXL storage 132a.

In some embodiments, the host 110 may generate a plurality of process information. The process information may be data indicating the address to which the process data is assigned. The host 110 may transmit the plurality of process information to the CXL device 130a.

The step (S501) is described with reference to FIG. 6.

FIG. 6 is a mapping table showing the logic address where data for each process is stored.

The first mapping table 600 may store the logic address 603 corresponding to each of the plurality of processes data 601. The host 110 may create a first mapping table 600 by distinguishing the logical addresses for each process. For example, the host 110 may distinguish the plurality of logic addresses into logic addresses where a first process data required for a first process is stored, logic addresses where a second process data required for a second process is stored, logic addresses where a third process data required for a third process is stored, etc. to create a first mapping table 600.

As shown in FIG. 6, a first process information 611 may indicate that the process data corresponding to the first process is allocated to the logic address (00-0F). At this time, the logic address (00-0F) may be a logic address included in the host memory 120.

A second process information 613 may indicate that the process data corresponding to the second process is allocated to the logic address (20-2F). At this time, the logic address (20-2F) may be a logic address included in the CXL memory 133a.

A third process information 615 may indicate that the process data corresponding to the third process is allocated to the logic address (10-1F). At this time, the logic address (10-1F) may be a logic address included in the CXL storage 132a.

Meanwhile, as shown in FIG. 6, the host 110 may divide and allocate the process data required to drive one process to the host memory 120, the CXL memory 133a, and the CXL storage 132a. Additionally, the host 110 may allocate the process data needed to drive the different processes to one memory, and may also allocate them together to the same logic address within the memory.

The host 110 maps the CXL address to each of the plurality of logic addresses corresponding to the host memory 120 (S503).

In some embodiments, the process information may further include a CXL address mapped to the logic address to which the process data is assigned.

Afterwards, the CXL controller 131a maps the CXL address to each of the plurality of logic addresses corresponding to the CXL memory 133a and the CXL storage 132a (S505).

Specifically, the CXL controller 131a may receive the plurality of process information from the host 110. The CXL controller 131a may map the CXL address to each of the plurality of logic addresses corresponding to the CXL memory 133a and the CXL storage 132a.

The step (S503) and the step (S505) refer to FIG. 7 and FIG. 8 together.

FIG. 7 is a mapping table showing the CXL addresses corresponding to the plurality of logic addresses. FIG. 8 is a mapping table showing the process data corresponding to the CXL address.

The second mapping table 700 may store the logic address 703 and the CXL address 705 corresponding to each of the plurality of processes data 701. The CXL controller 131a may receive the plurality of process information from the host 110 to create a second mapping table 700.

As shown in FIG. 7, a first process information 711 may indicate that the process data corresponding to the first process is allocated to a logic address (00-0F) and a CXL address (00-0F).

A second process information 713 may indicate that the process data corresponding to the second process is allocated to a logic address (20-2F) and a CXL address (80-8F).

A third process information 715 may indicate that the process data corresponding to the third process is allocated to a logic address (10-1F) and a CXL address (40-4F).

As shown in FIG. 8, the third mapping table 800 may store the plurality of processes data 701 and the CXL address 705. The CXL controller 131a may create a third mapping table 800 by aligning the second mapping table 700 with the CXL addresses included in the same memory region as a reference.

On the other hand, in FIG. 5, it is described that the host 110 sequentially performs the step S503 in which the plurality of logic addresses corresponding to the host memory 120 is mapped to the CXL address, and the step S505 in which the CXL address is mapped to each of the plurality of logic addresses corresponding to the CXL memory 133a and the CXL storage 132a, but the order of mapping the plurality of logic addresses to the CXL addresses is not limited thereto. For example, the computing system 100 may also simultaneously perform the step that the host 110 maps the plurality of logic addresses for the host memory 120 to the CXL address, and the step that the CXL controller 131a maps the plurality of logic addresses for the CXL memory 133a and the CXL storage 132a to the CXL addresses.

The CXL storage 132a maps a physical address corresponding to the CXL address (S507).

Specifically, the storage controller (200 in FIG. 2) may receive the CXL address from the CXL controller 131a. The FTL (220 in FIG. 2) may map the physical address in the non-volatile memory (201 in FIG. 2) corresponding to the CXL address.

The host 110 may distinguish the CXL addresses for each memory region. For example, the host 110 may determine a valid bit for the CXL address included in the CXL storage. Afterwards, host 110 may transmit information including the CXL address and a valid bit corresponding to the CXL address to the CXL storage 132a.

Afterwards, the host 110 updates the valid bit corresponding to the terminated process among the plurality of processes (S509).

The host 110 may generate the update information when the valid bit changes. In some embodiments, the host 110 may create or generate an update information when the valid bit corresponding to the logic address included in the CXL storage 132a changes. The host 110 may transmit the update information to the CXL storage 132a through the CXL controller 131a. The update information may include a logic address corresponding to the changed valid bit and the changed valid bit. The CXL controller 131a may determine the CXL address corresponding to the logic address based on the second mapping table 700 and the third mapping table 800. At this time, the CXL controller 131a may select the CXL address included in the CXL storage 132a among the CXL addresses. The CXL controller 131a may transmit the selected CXL address to the CXL storage 132a. The storage controller (200 in FIG. 2) may update the valid bit corresponding to the CXL address received from the CXL controller 131a.

The step (S507) is described with reference to FIG. 9. FIG. 9 is a mapping table showing a physical address and a valid bit corresponding to the CXL address.

The CXL storage 132a may create a fourth mapping table 900 for the CXL addresses included in the CXL storage 132a.

The fourth mapping table 900 may store CXL address 905, a process data 901 corresponding to the CXL address 905, and a physical address 907 corresponding to each CXL address 905.

As shown in FIG. 9, the first process information 911 may indicate that the process data corresponding to the fourth process is allocated to a CXL address (30-3F) and a physical address (00-0F).

The second process information 913 may indicate that the process data corresponding to the third process is allocated to a CXL address (40-4F) and a physical address (10-1F).

The third process information 915 may indicate that the process data corresponding to the fourth process is allocated to a CXL address (50-5F) and a physical address (20-2F).

Meanwhile, the fourth mapping table 900 may further store the valid bit corresponding to each CXL address 905. In some embodiments, when the valid bit is 1, it may indicate that the process is driving, running, or executing, and when the valid bit is 0, it may indicate that the process is terminated. Since each of the plurality of processes may be driving, running, or executing, all valid bits corresponding to the plurality of CXL addresses (30-3F, 40-4F, 50-5F) may be 1.

For example, it is assumed that the fourth process terminates. The host 110 may generate update information including the logic address corresponding to the fourth process among the plurality of logic addresses and the changed valid bit. That is, the update information including the logic address (00-0F) of the CXL storage 132a corresponding to the fourth process, the logic address of the CXL storage 132a (10-1F), and the logic address (20-2F) of the CXL memory 133a in the first mapping table 600 may be created.

The CXL controller 131a may determine that the logic address (00-0F) of the CXL storage 132a corresponds to the CXL address (30-3F), the logic address (10-1F) of the CXL storage 132a corresponds to the CXL address (50-5F), and the logic address (20-2F) of the CXL memory 133a corresponds to the CXL address (60-6F). Meanwhile, the CXL controller 131a may select the CXL address included in the CXL storage 132a among the CXL addresses. That is, the CXL controller 131a may select the CXL address (30-3F) and the CXL address (50-5F). The storage controller 200 may update the valid bits corresponding to the CXL address (30-3F) and the CXL address (50-5F). Accordingly, the storage controller 200 may change the valid bit included in the first process information 911 and the valid bit included in the third process information 915 from 1 to 0 in the fourth mapping table 900.

Meanwhile, in FIG. 9, the fourth mapping table 900 is shown as including the physical address, but the present disclosure is not limited thereto and the fourth mapping table 900 may not include a physical address.

The CXL storage 132a performs a garbage collection for the non-volatile memory based on the valid bit (S511).

Specifically, the storage controller 200 may perform a garbage collection that removes a page where the invalid data is stored based on the valid bit corresponding to the CXL address and merges the pages where the valid data is stored.

In summary, when the process is terminated, host 110 may change the valid bit corresponding to the logic address including data for the terminated process and create or generate an update information including the changed valid bit and the corresponding logic address. In some embodiments, the host 110 may change the valid bit corresponding to the CXL address including data about the terminated process and generate an update information including the changed valid bit and the corresponding CXL address. The host 110 may transmit the update information to the CXL controller 131a. Afterwards, the storage controller 200 may determine a physical address corresponding to the CXL address and perform a garbage collection on the determined physical address.

Therefore, the CXL storage 132a may perform garbage collection on the page including the data for the terminated processes, and thus may manage the data efficiently.

Although the mapping table is described with reference to FIG. 6 to FIG. 9 as an example, this is for illustrative purposes and the computing system 100 does not need to create the mapping table. Additionally, the data included in each mapping table may also be changed appropriately.

Meanwhile, the present disclosure is not limited thereto, and the host 110 may generate a separate trim command based on the valid bit. The trim command may be a command notifying that data existing in a specific region of the CXL storage 132a is no longer used to the CXL storage 132a. The CXL storage 132a may perform a garbage collection as it receives a trim command from the host 110.

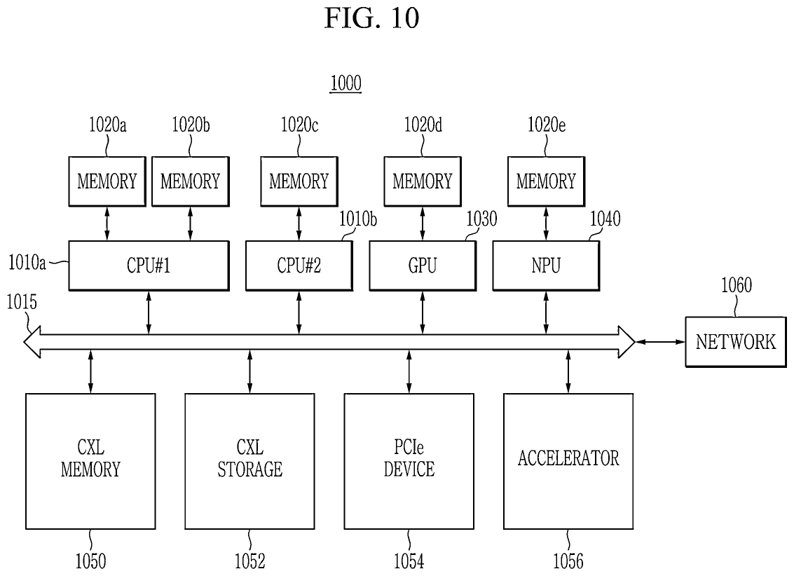

FIG. 10 is a block diagram showing a computing system according to some embodiments.

Referring to FIG. 10, a computing system 1000 may include a first CPU 1010a, a second CPU 1010b, a GPU 1030, an NPU 1040, a CXL switch 1015, a CXL memory 1050, a CXL storage 1052, a PCIe device 1054, and an accelerator (a CXL device) 1056.

The first CPU 1010a, the second CPU 1010b, the GPU 1030, the NPU 1040, the CXL memory 1050, the CXL storage 1052, the PCIe device 1054, and the accelerator 1056 may be commonly connected to the CXL switch 1015, and may respectively communicate with each other through the CXL switch 1015.

In some embodiments, the first CPU 1010a, the second CPU 1010b, the GPU 1030, and the NPU 1040 may be respectively the host described with reference to FIG. 1 to FIG. 9, and each may be directly connected to the individual memories 1020a, 1020b, 1020c, 1020d, and/or 1020c.

In some embodiments, the CXL memory 1050, the CXL storage 1052, and the accelerator 1056 may be the CXL device described with reference to FIG. 1 to FIG. 9. Work may be distributed to the CXL memory 1050, the CXL storage 1052, and the accelerator 1056 by one or more of the first CPU 1010a, the second CPU 1010b, the GPU 1030, and the NPU 1040, and work may be distributed to the CXL memory 1050, the CXL storage 1052, and the accelerator 1056 by one or more of the CXL memory 1050, the CXL storage 1052, and/or the accelerator 1056.

In some embodiments, the CXL switch 1015 may be connected to the PCIe device 1054 or the accelerator 1056 configured to support various functions, and the PCIe device 1054 or the accelerator 1056 may communicate with each of the first CPU 1010a, the second CPU 1010b, the GPU 1030, and the NPU 1040 through the CXL switch 1015 or access the CXL memory 1050 and the CXL storage 1052.

In some embodiments, the CXL switch 1015 may be connected to an external network 1060 or a fabric such as a switch fabric, and may be configured to communicate with an external server through the external network 1060 or the fabric.

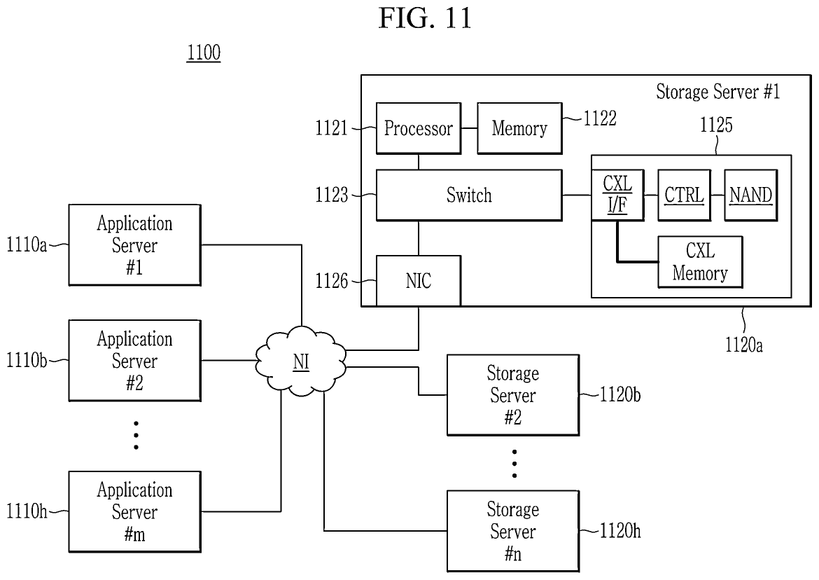

FIG. 11 is a block diagram showing a server system according to some embodiments.

Referring to FIG. 11, a data center 1100, which is a facility that collects various data, provides services, may also be referred to as a data storage center. The data center 1100 may be a system for operating a search engine and a database, and may be a computer system used in a government or corporate institution such as a bank. The data center 1100 may include application servers 1110a, . . . , 1110h and storage servers 1120a, . . . , 1120h. A number of application servers and a number of storage servers may be variously selected according to some embodiments, and may be different from each other.

Hereinafter, a configuration of the first storage server 1120a will be mainly described. Each of the application servers 1110a, . . . , 1110h and the storage servers 1120a, . . . , 1120h may have a structure similar to each other, and may communicate with each other through a network NT.

The first storage server 1120a may include a processor 1121, a memory 1122, a switch 1123, a CXL device 1125, and a network interface card (NIC) 1126. The processor 1121 may control the overall operation of the first storage server 1120a and may access the memory 1122 to execute instructions loaded in the memory 1122 or process data. The processor 1121 and the memory 1122 may be directly connected, and the number of the processors 1121 and the number of the memories 1122 included in one storage server 1120a may be variously selected.

In some embodiments, the processor 1121 and the memory 1122 may provide a processor-memory pair. In some embodiments, the number of the processors 1121 and the number of the memories 1122 may be different. The processor 1121 may include a single-core processor or a multi-core processor. The above description of the storage server 1120 may be similarly applied to each of the application servers 1110a, . . . , and 1110h.

The switch 1123 may be configured to mediate or route communication between various components included in the first storage server 1120a. In some embodiments, the switch 1123 may be the CXL switch described in FIG. 2 and FIG. 5, and the like. That is, the switch 1123 may be a switch implemented based on a CXL protocol.

The CXL device 1125 may be the CXL device described with reference to FIG. 1 to FIG. 9. The CXL device 1125 may include a CXL interface circuit CXL_IF, a controller CTRL, a NAND flash NAND, and a CXL memory.

The CXL device 1125 may be connected to the switch 1123. The CXL device 1125 may store data or output a stored data according to the request of the processor 1121.

In the first storage server 1120a according to some embodiments, the processor 1121 may generate an update information when the connection relationship with some application servers among the connected application servers 1110a, . . . , 1110h changes. The controller CTRL may perform a garbage collection operation of the NAND flash NAND based on the update information. For example, the controller CTRL may remove a page including data corresponding to the application servers whose connections have been terminated, and may program a page including data corresponding to the application servers whose connections have not been terminated into a new page. Accordingly, the CXL device 1125 may efficiently manage data stored in the NAND flash NAND.

The application servers 1110a, . . . , 1110h may not include the storage, in some embodiments.

The network interface card (NIC,) 1126 may be connected to the CXL switch 1123. The NIC 1126 may communicate with other storage servers 1120a, . . . , 1120h or other application servers 1110a, . . . , 1110h through a network (NT).

In some embodiments, the NIC 1126 may include a network interface card, a network adapter, and the like. The NIC 1126 may be connected to the network NT by a wired interface, a wireless interface, a Bluetooth interface, an optical interface, or the like. The NIC 1126 may include an internal memory, a digital signal processor (DSP), a host bus interface, and the like, and may be connected to the processor 1121 and/or switch 1123 through the host bus interface. In some embodiments, the NIC 1126 may be integrated with at least one of a processor 1121, a switch 1123, or the CXL device 1125.

In some embodiments, the network NT may be implemented using a fiber channel (FC), Ethernet, or the like. In this case, the FC, which is a medium used for relatively high-rate data transmission, may use an optical switch providing high performance and high availability. The storage servers may be provided as file storage, block storage, or object storage depending on an access method of the network NT.

In some embodiments, the network NT may be a storage-only network, such as a storage area network (SAN). For example, the SAN may be an FC-SAN that uses an FC network and is implemented depending on an FC protocol (FCP). As another example, the SAN may be an IP-SAN that uses a TCP/IP network and is implemented depending on an iSCSI (SCSI over TCP/IP or Internet SCSI) protocol. In some embodiments, the network NT may be a general network such as a TCP/IP network. For example, the network NT may be implemented depending on protocols such as FC over Ethernet (FCoE), Network Attached Storage (NAS), and NVMe over Fabrics (NVMe-oF).

In some embodiments, at least one of the application servers 1110a, . . . , and 1110h may store data requested to be stored by a user or a client in one of the storage servers 1120a, . . . , and 1120h through the network NT. At least one of the application servers 1110a, . . . , and 1110h may acquire data requested by a user or a client to be read from one of the storage servers 1120a, . . . , and 1120h through the network NT. For example, at least one of the application servers 1110a, . . . , and 1110h may be implemented as a web server or a database management system (DBMS).

In some embodiments, at least one of the application servers 1110a, . . . , and 1110h may access a memory, a CXL memory, or a storage device included in another application server through the network NT, or may access memories, CXL memories, or storage devices included in the storage servers 1120a, . . . , and 1120h through the network NT. Accordingly, at least one of the application servers 1110a, . . . , and 1110h may perform various operations on data stored in other application servers and/or storage servers. For example, at least one of the application servers 1110a, . . . , and 1110h may execute a command to move or copy data between other application servers and/or storage servers. In this case, data may be moved to the memory or the CXL memory of the application servers directly or from the storage device of the storage servers through the memories or CXL memories of the storage servers. Data moving through the network may be encrypted for a security or privacy.

In some embodiments, each component or combinations of two or more components described with reference to FIG. 1 to FIG. 11 may be implemented as a digital circuit, a programmable or non-programmable logic device or array, an application specific integrated circuit (ASIC), or the like.

While this disclosure has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

1. A computing system comprising:
a host configured to distribute and allocate process data associated with a plurality of processes to a plurality of logic addresses, determine a valid bit corresponding to a logic address among a plurality of logic addresses, the valid bit indicating whether a process among the plurality of the processes corresponding to the logic address is executing, and generate an update information including the valid bit and the logic address corresponding to the valid bit; and
a storage device configured to receive the update information from the host.

2. The computing system of claim 1, wherein the storage device includes a plurality of non-volatile memories, and the storage device is configured to perform garbage collection on the plurality of non-volatile memories based on the update information.

3. The computing system of claim 1, wherein the host is configured to generate the update information in response to the valid bit changing.

4. The computing system of claim 1, further comprising:
a CXL device logically connected to the host through a CXL interface,
wherein the CXL device includes the storage device, and
wherein a CXL controller is configured to map a first type of a first logic address among the plurality of logic addresses to a storage address for the storage device.

5. The computing system of claim 4, wherein the CXL device further includes a CXL memory including a volatile memory corresponding to a second logic address among the plurality of logic addresses of a second type, and the CXL controller is configured to map the second logic address of the second type to a CXL memory address for the CXL memory.

6. The computing system of claim 5, wherein the computing system further comprises:
a host memory logically connected to the host and including a volatile memory corresponding to a third type of a third logic address among the plurality of logic addresses.

7. The computing system of claim 6, wherein the logic address corresponding to the valid bit is selected from the first logic address of the first type, the second logic address of the second type, or the third logic address of the third type.

8. The computing system of claim 1, wherein the host is configured to distribute and allocate the process data to the plurality of logic addresses based on at least one of a consistency or an input/output speed of the process data.

9. A method of a computing system comprising:
distributing and allocating process data associated with a plurality of processes to respective ones of a plurality of logic addresses,
determining a valid bit corresponding to a logic address among a plurality of logic addresses, the valid bit indicating whether a process among the plurality of processes corresponding to the logic address is executing,
generating update information including the valid bit and the logic address corresponding to the valid bit,
mapping a first logic address among the plurality of logic addresses of a first type to a storage address for a storage device including a non-volatile memory, and
performing garbage collection on the storage device at the storage address corresponding to the logic address in response to the valid bit indicating that the process is not executing based on the update information.

10. The method of the computing system of claim 9, further comprising:
mapping a second logic address of a second type among the plurality of logic addresses to a CXL memory address for a CXL memory including a volatile memory.

11. The method of the computing system of claim 10, further comprising:
mapping a third logic address among the plurality of logic addresses of a third type to the CXL memory address for a host memory including a volatile memory.

12. The method of the computing system of claim 11, wherein the generating of the update information includes generating the update information including the valid bit that corresponds to the logic address selected from the first logic address of the first type, a second logic address of the second type, or a third logic address of the third type.

13. The method of the computing system of claim 9, wherein the distributing and assigning to the plurality of logic addresses includes distributing and assigning the process data to the plurality of logic addresses based on at least one of a consistency or an input/output speed of the process data.

14. The method of the computing system of claim 9, wherein the generating of the update information includes generating the update information in response to the valid bit changing.

15. A CXL device comprising:
a CXL storage including a non-volatile memory corresponding to a first type of a first logic address among a plurality of logic addresses, the CXL storage is configured to receive a valid bit corresponding to the first logic address among the plurality of logic addresses, the valid bit indicating whether a process among a plurality of processes corresponding to the first logic address of the first type is executing, and perform garbage collection for the non-volatile memory based on the valid bit; and
a CXL memory including a volatile memory corresponding to a second type of a second logic address among the plurality of logic addresses.

16. The CXL device of claim 15, further comprising:
a CXL controller is configured to map the first logic address of the first type to a CXL storage address for the CXL storage, and map the second logic address of the second type to a CXL memory address for the CXL memory.

17. The CXL device of claim 16, wherein the CXL storage includes a flash translation layer (FTL) that maps the CXL storage address to a physical address of the non-volatile memory.

18. The CXL device of claim 17, wherein the FTL performs the garbage collection at the CXL storage address of the CXL storage corresponding the valid bit indicating the process that is not executing.

19. The CXL device of claim 16, wherein the CXL controller is configured to receive the valid bit through a CXL interface.

20. The CXL device of claim 15, wherein the CXL storage is configured to receive the valid bit in response to the executing of the process changes.
